(19) United States
(12) Patent Application Publication
(10) Pub. No.: US 2018/0141619 A1
(43) Pub. Date: May 24, 2018

(54) COVER LATCH AND LOCKING SYSTEM

(71) Applicant: DTS Enterprises, Inc., Ellsworth, MI (US)

(72) Inventors: David L. Draper, Charlevoix, MI (US); Keith S. Attee, Charlevoix, MI (US)

(21) Appl. No.: 15/819,250

(22) Filed: Nov. 21, 2017

Related U.S. Application Data
(60) Provisional application No. 62/424,793, filed on Nov. 21, 2016.

(51) Int. Cl. B63B 17/02; E05B 63/12

(52) U.S. Cl. CPC B63B 17/02; E05Y 2900/514; E05B 63/121

(57) ABSTRACT

A cover latch and locking system includes a first attachment device and a second attachment device. The first attachment device may include a hoop that may be configured to receive a rope, a line, or a cable (which may be referred to generally as a “line” or “rope”). The first attachment device may include a handle that may be configured to engage and/or disengage a locking feature (e.g., via a spring-loaded ball bearing). The second attachment device may include a bracket that may, for example, be configured to receive a line, such as via an aperture or hole configured to receive the line. The second attachment device can include a cam, which may be configured to rotate (e.g., revolve) about a pin and/or the bracket. The second attachment device may include a button that may be configured to engage and/or disengage a locking feature.

### CROSS-REFERENCE TO RELATED APPLICATION

This application claims the benefit of U.S. Provisional Patent Application Ser. No. 62/424,793, filed on Nov. 21, 2016, the disclosure of which is hereby incorporated herein by reference in its entirety.

### TECHNICAL FIELD

The present disclosure relates to methods and systems pertaining to covers and cover latches and locks, including boat cover latches and locking systems.

### BACKGROUND

Vehicles commonly have openings, such as a cockpit and/or passenger-carrying area. Such openings may be optionally covered by a cover that may be made of a flexible material, such as a canvas. A cockpit and/or passenger-carrying area, for example on a boat, may be bounded at least partially by a windshield (e.g., windscreen). Typical covers for a cockpit and/or passenger-carrying area may include a plurality of snaps that may engage a similar plurality of snaps situated about the perimeter of the windshield and/or other adjacent portions. To secure a cover to the windshield, a plurality of snaps of the cover typically must be individually connected to a corresponding snap associated with the windshield. This process can be tedious and/or time-consuming. In addition, if the snaps are not carefully coordinated, a misalignment (e.g., a gap between the cover and windshield) may occur that may result in the cover not being adequately or completely secured with respect to the windshield. A misalignment may require some or all of the snaps to be unfastened and the process restarted.

It may be desirable to provide, inter alia, a cover latch and locking system that may close a cockpit and/or passenger-carrying area and/or address some or all of the conventional limitations.

### SUMMARY

In embodiments, a cover latch and locking system includes a first attachment device and a second attachment device. The first attachment device may include a hoop that may be configured to receive a rope, a line, or a cable (referred to generally as a “line” or “rope”). The first attachment device may include a handle that may be configured to engage and/or disengage a locking feature (e.g., via a spring-loaded ball bearing). The second attachment device may include a bracket that may, for example, be configured to receive a line, such as via an aperture or hole configured to receive the line. The second attachment device can include a cam, which in embodiments may be configured to rotate (e.g., revolve) about a pin and/or the bracket. The second attachment device may include a button that may be configured to engage and/or disengage a locking feature.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a top view generally illustrating an embodiment of a cover locking system that embodies teachings of the present disclosure.

FIGS. 2A and 2B are a side view and a perspective view, respectively, generally illustrating embodiments of a second attachment device of a cover locking system that embodies teachings of the present disclosure.

FIGS. 3A and 3B are a partial side view and a perspective view, respectively, generally illustrating embodiments of a first attachment device of a cover locking system that embodies teachings of the present disclosure.

FIGS. 4A and 4B are a sectional view and a side view, respectively, generally illustrating embodiments of an engaging portion of a first or second attachment device of a cover locking system that embodies teachings of the present disclosure.

FIG. 5 is a top perspective illustration of an embodiment of a cover locking system that embodies teachings of the present disclosure.

FIG. 6 is a partial perspective view generally illustrating a portion of a boat windshield with rail and mullion associated with an embodiment of a second attachment device in association with a cover locking system embodying teachings of the present disclosure.

FIG. 7 is a perspective view generally illustrating a portion of a boat windshield with rail and mullion associated with an embodiment of a cover locking system embodying teachings of the present disclosure.

### DETAILED DESCRIPTION

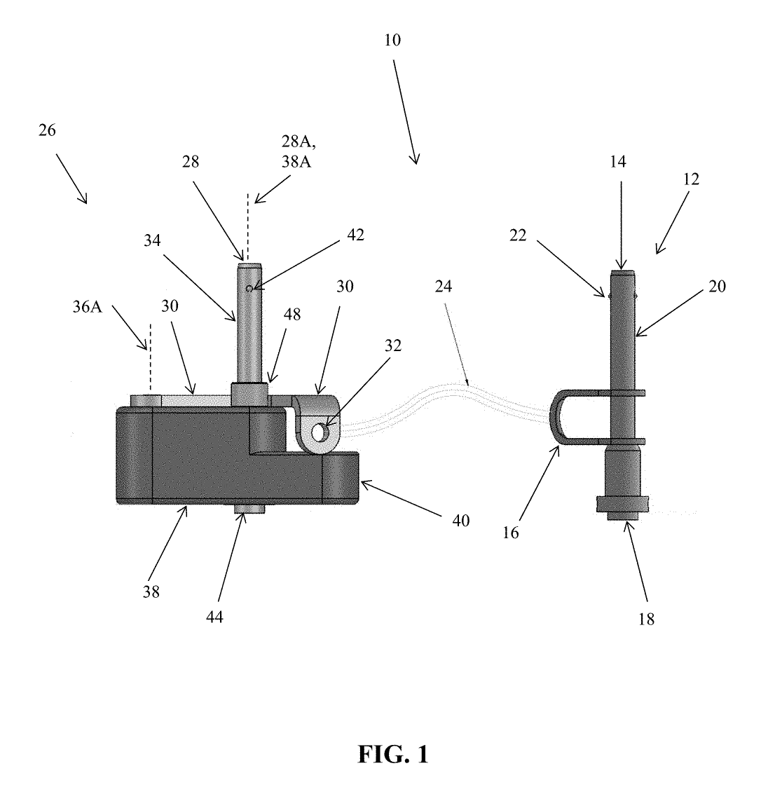

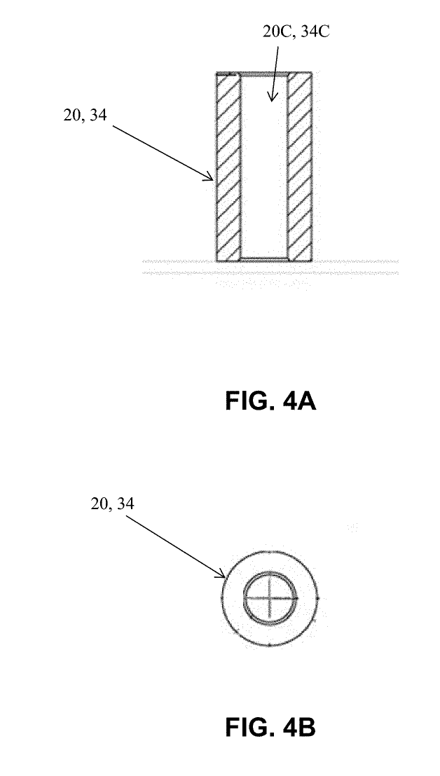

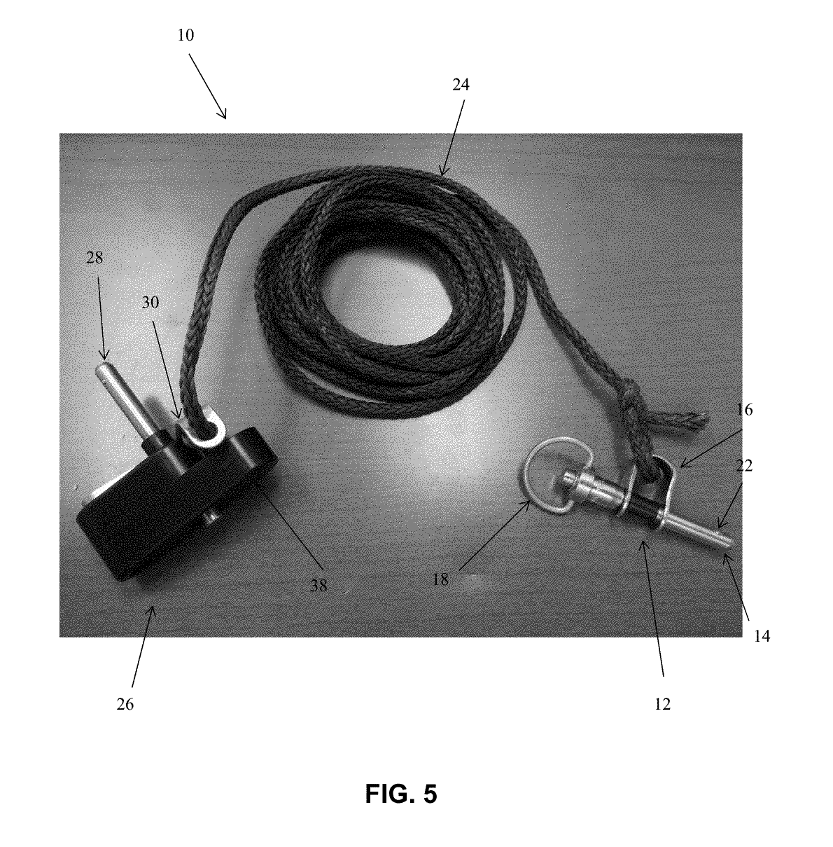

Referring now to the drawings, FIGS. 1, 2A, 2B, 3A, 3B, 4A, 4B, and 5 generally illustrate embodiments of cover latch and locking systems (“system” or “systems”) 10, which may be utilized, for example, in connection with a base or mount, such as a boat. As generally illustrated, a latch and locking system 10 may include a first attachment device 12 and a second attachment device 26. In an embodiment, a first attachment device 12 may, for example, include a pin 14, an attachment formation 16, a handle/button 18, an engaging portion 20, and/or a pin locking mechanism 22. A locking system 10 may include a rope, a line, or a cable (collectively referred to herein as a “line” or a “rope,” and generically identified as element 24) that may be tied or secured to an attachment formation 16.

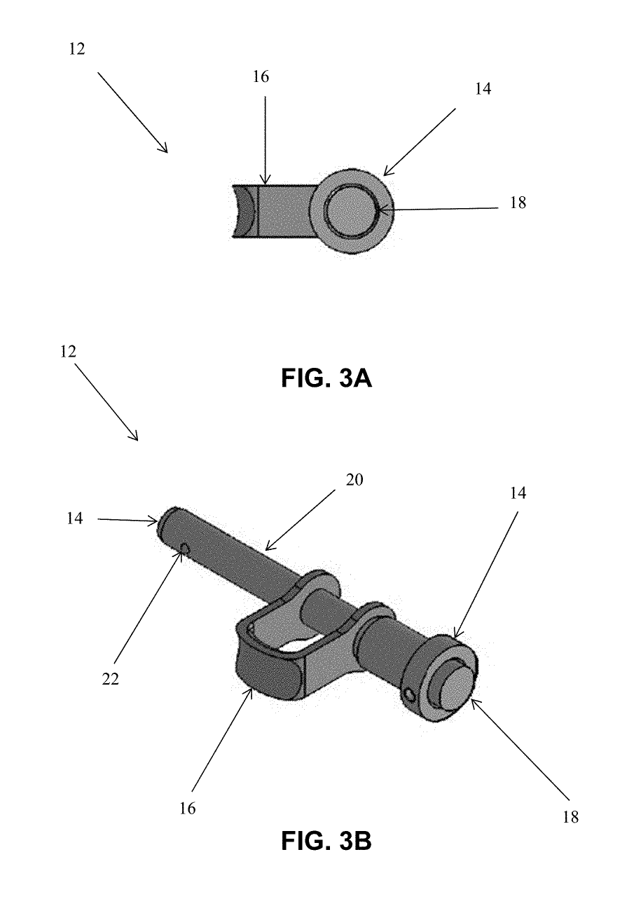

In embodiments, such as generally illustrated in FIGS. 3A and 3B, a pin 14 of a first attachment device 12 of system 10 may be connected to and/or include an attachment formation 16. An attachment formation 16 may include a hoop or hoop-shaped or U-shaped configuration and may be referred to herein as hoop 16, but is not limited to a hoop-shaped configuration. Hoop 16 may be configured to connect to or receive a line or rope 24. Line or rope 24 may, for example, be secured or tied to hoop 16. For example and without limitation, line or rope 24 may be secured and/or connected to hoop 16 via a knot, adhesive and/or other mechanical connection or bond. In embodiments, line or rope 24 may be connected or secured to hoop 16 such that line or rope 24 may be permitted to move relative to (e.g., rotate about and/or around) hoop 16. In embodiments, hoop 16 may be configured (e.g., disposed) on an engaging portion 20 of first attachment device 12. In embodiments, hoop 16 may be configured to rotate about a pin 14 of first attachment device 12. Additionally or alternatively, hoop 16 may be configured to be fixed relative to pin 14 of first attachment device 12.

With embodiments, a pin (or pin portion) 14 of a first attachment device 12 of system 10 may include a handle/button 18. Handle/button 18 may be configured or disposed on or about an end of pin 14, for example, at or about an end of pin 14 opposite of an engaging portion 20. Handle/button 18 may be connected to a locking system 22 and may be configured or disposed at least partially within pin 14. For example and without limitation, pin 14 may include a hollow cavity 20C that may contain at least a portion of locking system 22. Handle/button 18 may be actuated (e.g., via pushing/pulling) that may result in the operation (e.g., locking/unlocking) of locking mechanism 22. If desired, handle/button 18 may be configured to include a visual and/or audible indicator of a condition (e.g., locked or unlocked) of locking mechanism 22.

In embodiments, such as generally illustrated in FIGS. 1, 3B, 4A, and 4B, a pin 14 of a first attachment device 12 of system 10 may include an engaging portion 20. Engaging portion 20 may include at least a portion of a pin locking mechanism 22. An engaging portion 20 may be configured to engage one or more elements of a boat (e.g., a boat windshield) via a corresponding hole and/or other receptacle 54. Engaging portion 20 may be connected to and/or include a hoop 16. Hoop 16 may be configured to rotate about engaging portion 20. Additionally or alternatively, hoop 16 may be configured to be fixed relative to engaging portion 20. In embodiments, engaging portion 20 may include surface treating or formations (e.g., tapered edges, coatings, etc.) that may facilitate engagement with one or more elements of a boat. Hoop 16 may limit an insertion depth of pin 14.

In embodiments, a pin 14 of a first attachment device 12 of system 10 may include a pin locking mechanism 22. A pin locking mechanism 22 may at least partially be configured within pin 14. A portion of locking system 22 may extend beyond pin 14, such as through a hole (e.g., aperture) that may be configured in an engaging portion 20 of pin 14. In embodiments, pin locking mechanism 22 may include a spring-loaded ball bearing. Pin locking mechanism 22 may be actuated (e.g., locked, unlocked) via a handle/button 18 that may be included with pin 14. Additionally or alternatively, pin locking mechanism 22 may be actuated (e.g., over-ridden) by the insertion and/or removal of pin 14 from an element (e.g., a windshield) of a boat via handle/button 18. In embodiments, a pin locking mechanism 22 may include magnets (e.g., rare earth magnets). The magnets may provide an attraction force with respect to a windshield of a boat to facilitate connection of first attachment device 12 to a base, such as to a windshield mullion 52, for example.

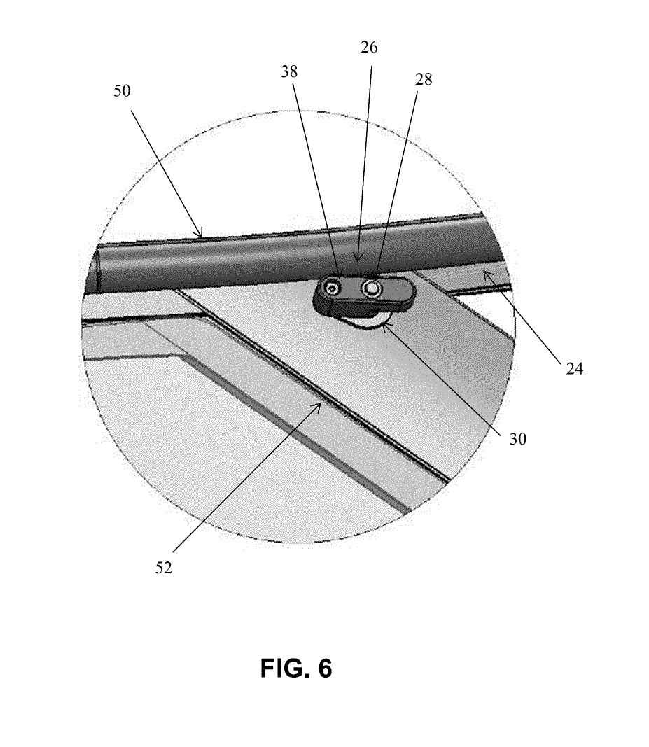

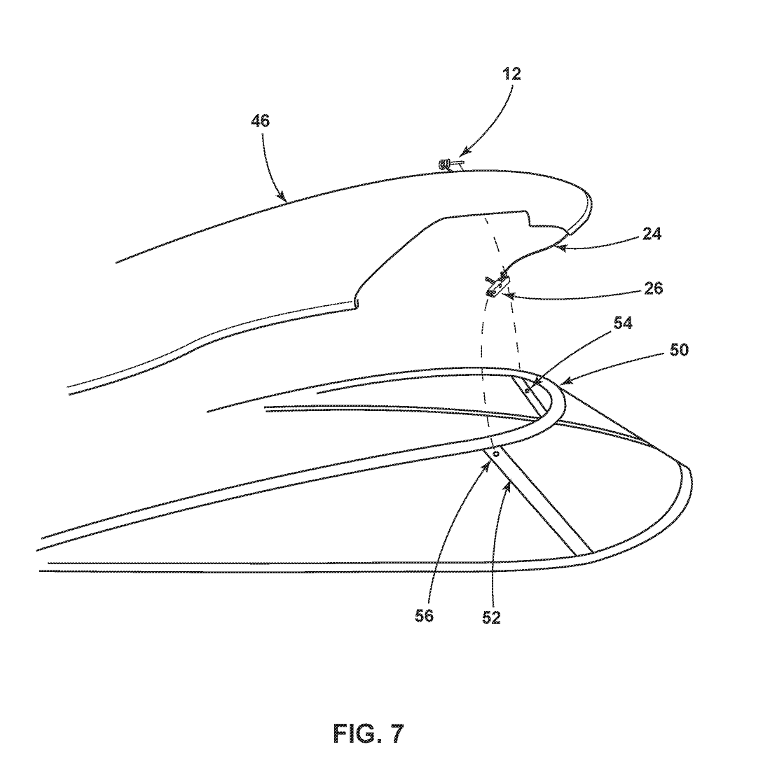

A line or rope (e.g., cable) 24 may be secured or tied to a first attachment device 12 of system 10. A line or rope 24 may be of a predetermined length such that if system 10 is deployed with a cover 46 of a boat windshield/cockpit area (see, e.g., FIGS. 6 and 7), for example, line or rope 24 may be configured to provide a desired or predetermined amount of tension (e.g. retaining force) in a system 10. In embodiments, such as generally illustrated, a line or rope 24 may be configured to connect to a cover 46 (e.g., a boat cover) and tension a portion of cover 46 around or about a cockpit or open area of a boat. In embodiments, line or rope 24 may also be secured to a second attachment device 26 of system 10 via an aperture or hole 32 configured in a bracket 30 of second attachment device 26.

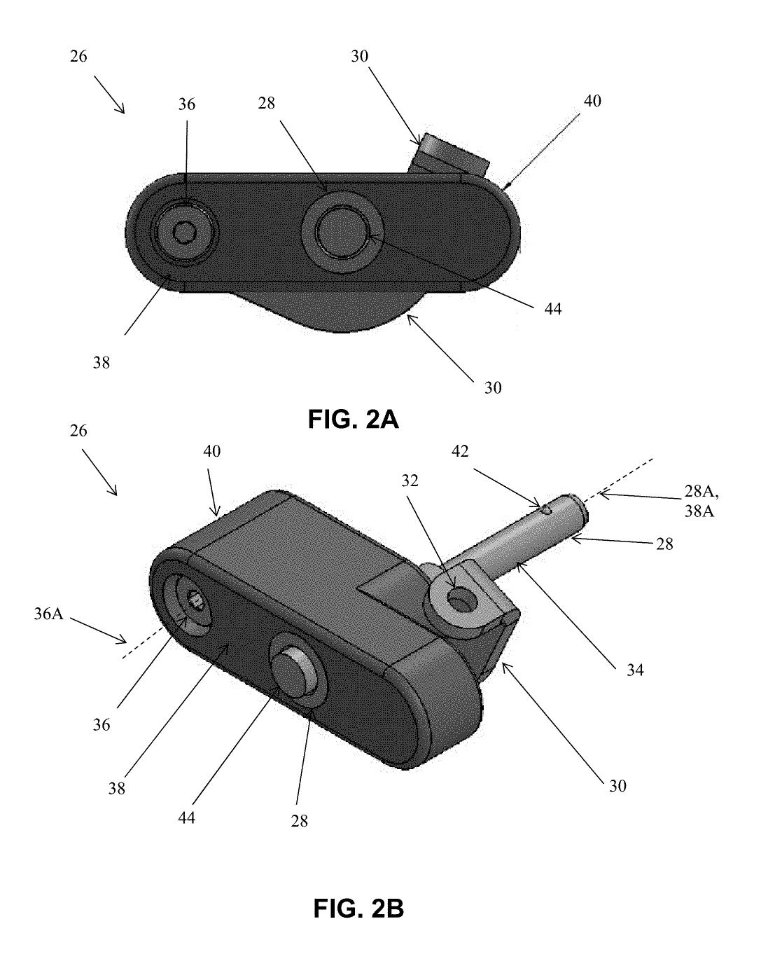

In embodiments, such as generally illustrated in FIGS. 2A and 2B, a second attachment device 26 of a locking system 10 may include a pin 28, a bracket 30, a fastener 36, and/or a cam 38. A pin 28 may include and/or be connected to a bracket 30. Bracket 30 may include an aperture or hole 32 that may be configured to receive and/or connected with a line or rope 24. Bracket 30 may be configured to pivot (e.g., rotate) about pin 28 and/or fastener 36 (e.g., about an axis 28A of pin 28 and/or about an axis 36A of fastener 36). In embodiments, bracket 30 may be securely and/or rotatably attached to a cam 38 via a fastener 36. Additionally or alternatively, bracket 30 may be securely and/or rotatably attached to cam 38 via a pin 28. Bracket 30 may be configured to rotate relative to cam 38 about an axis 36A. Cam 38 may be configured to rotate about an axis 38A that may be offset (e.g., radially) from axis 36A. Axis 38A may be substantially coincident with an axis 28A of pin 28. Bracket 30 may include, for example and without limitation, an L-shaped configuration.

In embodiments, a pin 28 of a second attachment device 26 of system 10 may include an engaging portion 34. Engaging portion 34 may include at least a portion of a pin locking mechanism 42. Engaging portion 34 may, for example, be configured to engage one or more elements of a boat (e.g., a boat windshield or windshield mullion 52) via a corresponding hole and/or other receptacle. Engaging portion 34 may be configured to include and/or to connect with a bracket 30. Bracket 30 may be configured to rotate about engaging portion 34. Additionally or alternatively, bracket 30 may be configured to be fixed relative to engaging portion 34. Engaging portion 34 may include surface treating or formations (e.g., tapered edges, coatings, etc.) that may facilitate engagement with one or more elements of a boat (e.g., windshield mullion 52).

In embodiments, a pin 28 of a second attachment device 26 of system 10 may include a pin locking mechanism 42. Pin locking mechanism 42 may be disposed at least partially within pin 28. A portion of pin locking mechanism 42 may extend (e.g., radially) beyond pin 28, such as through a hole (e.g., aperture) that may be disposed at least partially in an engaging portion 34 of pin 28. Engaging portion 34 may include a cavity 34C that may be configured to at least partially receive pin locking mechanism 42. In embodiments, pin locking mechanism 42 may include a spring-loaded ball bearing. Pin locking mechanism 42 may be actuated (e.g., locked, unlocked) via a handle/button 44 that may be included on pin 28. Additionally or alternatively, pin locking mechanism 42 may be actuated (e.g., over-ridden) by the insertion and/or removal of pin 28 from an element (e.g., a windshield) of a boat via handle/button 44. In embodiments, a pin locking mechanism 42 may include magnets (e.g., rare earth magnets). The magnets may provide an attraction force with respect to portions of a windshield to, for example, facilitate connection of second attachment device 26 to a base (e.g., windshield mullion 52).

With embodiments, a pin 28 of a second attachment device 26 may be connected to and/or include a cam 38. Cam 38 may be connected to pin 28 such that cam 38 may rotate about pin 28. In embodiments, cam 38 may engage a bracket 30 via pin 28 and/or fastener 36. Cam 38 may comprise a material (e.g., polymer) that, among other things, may prevent or limit damage to elements of a boat (e.g., a boat windshield) that may interact with cam 38. Cam 38 may include one or more cam surfaces 40 that may be disposed about the perimeter of cam 38. Cam surface 40 may include some or all of the exterior of cam 38. Cam 38 and/or cam surface 40 may include surface treatments (e.g., textures) that may, for example, improve engagement (e.g., gripping, adhesion) with a boat windshield. In embodiments, a cam 38 of a second attachment device 26 may be configured to engage an aperture in a windshield rail 50, a windshield mullion 52, and/or another component or element of a base (e.g., a boat). Cam 38 may rotate (e.g., revolve) about a pin 28 and/or a fastener 36 of second attachment device 26 and/or may increase tension on a line or rope 24 that may be connected to a first attachment device and an additional aperture. For example and without limitation, rotation of cam 38 may cause rotation of bracket 30, which may pull on and/or increase the tension of line or rope 24. As bracket 30 rotates, line or rope 24 may wind around (or unwind from) one or more portions of second attachment device 26 (e.g., cam 38, bracket 30, pin 28, etc.).

With embodiments, the second attachment device 26 may be configured as an over center latch and/or provide functionality similar to that of an over center latch. Rotation of cam 38 and/or bracket 30 may continue beyond a point at which all pivots are aligned and the second attachment device 26 may latch or lock in such an over center position. If the line or rope 24 remains under tension, the second attachment device 26 may remain in a latched or locked position. A spacer 48 may be connected to the pin 28. The spacer 48 may provide a gap for the bracket 30, may protect a mating surface of the pin 28, and/or may limit over center rotation.

FIG. 6 generally illustrates a portion of a boat windshield rail 50, a portion of a windshield mullion 52, and an embodiment of a boat cover latch and locking system (“system”) 10. In embodiments, a second attachment device 26 may be inserted into an aperture 56 (e.g., a hole or recess) that may be disposed in windshield mullion 52. Additionally or alternatively, aperture 56 may be disposed in windshield rail 50 and/or another component or element of a boat. Second attachment device 26 may be inserted into aperture 56 in windshield mullion 52 via a pin 28 that may be configured (e.g., sized) such that pin 28 may have a smaller diameter than aperture 56. A pin locking mechanism 42 of second attachment device 26 may engage windshield to restrict 52 during insertion and/or removal of second attachment device 26.

In embodiments, a pin 28 of a second attachment device 26 may be inserted into an aperture 56 that may be disposed in a windshield rail 50, windshield mullion 52, and/or another component or element of a boat. Pin 28 may include some or all of an engaging portion 34 that may be configured for insertion into aperture 56. Aperture 56 may include additional securing features that may prevent the unintended removal of second attachment device 26 from the aperture of windshield rail 50, windshield mullion 52, and/or another element of the boat. A bracket 30 of second attachment device 26 may be configured to limit the insertion (e.g., an insertion depth) of pin 28 into aperture 56.

In operation, for example, a first attachment device 12 may be inserted into a first aperture 54 in windshield mullion 52 (see FIGS. 6 and 7). A second attachment device 26, connected to first attachment device 12 via a line or rope 24, may be inserted into a second aperture 56 in windshield mullion 52 (see, e.g., FIG. 6). At this point, line or rope 24 between first attachment device 12 and second attachment device 26 may have little or no tension (e.g., loading). Rotation of cam 38, such as about an axis 38A, in a first direction (e.g., opposite of line or rope 24) against one or more surfaces of windshield rail 50, windshield mullion 52, and/or another element of a boat may cause cam 38 and/or bracket 30 to place additional tension on line or rope 24. The additional tension on line or rope 24 may be transferred to a cover 46, which may cause cover 46 to engage or become “locked” with windshield rail 50. Due to the tension provided by line or rope 24 to cover 46, cover 46 may be secured to windshield rail 50, windshield mullion 52, and/or another component or element of a boat. To open (e.g., remove) cover 46, cam 38 may be returned to its previous position, such as via rotation in a second, opposite direction (e.g., away from line or rope 24), which may reduce tension in line or rope 24 and/or cover 46. Cover 46 may include a curved section that may correspond to a curved portion of a base or mount (e.g., a windshield rail 50 and/or a windshield mullion 52 of a boat).

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

It is intended that all matter contained in the above description or shown in the accompanying drawings shall be interpreted as illustrative only and not limiting. Changes in detail or structure may be made without departing from the present disclosure.

What is claimed is:

1. A cover locking system, comprising:
a line or rope;
a first attachment device, the first attachment device including a first pin and an attachment formation configured for connection with a first end of the line or rope; and
a second attachment device, the second attachment device including a second pin, a bracket configured for connection with a second end of the line or rope, and a cam connected to the second pin and the bracket, the cam configured to rotate the bracket.

2. The cover locking system of claim 1, wherein the line or rope is configured to connect to a cover and tension a portion of the cover around or about a cockpit or open area.

3. The cover locking system of claim 1, wherein the first pin includes a first pin locking mechanism including a spring-loaded ball bearing.

4. The cover locking system of claim 1, wherein the second pin includes a second pin locking mechanism including a spring-loaded ball bearing.

5. The cover locking system of claim 1, wherein the attachment formation includes a hoop configuration.

6. The cover locking system of claim 1, wherein the first pin includes a button configured to actuate a pin locking mechanism of the first pin.

7. The cover locking system of claim 1, wherein the bracket includes an aperture configured for connection with the second end of the line or rope.

8. The cover locking system of claim 1, wherein the bracket is rotatably connected to the cam via a fastener.

9. The cover locking system of claim 1, wherein the attachment formation limits an insertion depth of the first pin.

10. The cover locking system of claim 1, wherein the bracket is rotatably connected to the cam, and the cam is rotatably connected to the second pin.

11. The cover locking system of claim 10, wherein the bracket is configured to rotate relative to the cam about a first axis, the cam is configured to rotate about a second axis, and the first axis is offset from the second axis.

12. The cover locking system of claim 1, wherein the bracket includes an L-shaped configuration.

13. The cover locking system of claim 1, wherein the first pin includes a first engagement portion configured for engagement with a first aperture or recess of a base and the second pin includes a second engagement portion configured for engagement with a second aperture or recess of said base.

14. The cover locking system of claim 13, wherein said base includes at least one of a boat windshield rail and a boat windshield mullion.

15. The cover locking system of claim 2, wherein said cover is a fabric cover.

16. The cover locking system of claim 2, wherein said cover includes a curved section configured for connection with a curved portion of a boat; and the line or rope is configured for connection with the curved section of said cover.

17. A cover locking system, comprising:
a line or rope;
a first attachment device connected to the line or rope; and
a second attachment device connected to the line or rope;
wherein the second attachment device is configured to at least partially control a tension of the line or rope to selectively connect a cover with a base.

18. The cover locking system of claim 17, wherein:
the first attachment device includes a first pin configured for insertion into said base;
the second attachment device includes a second pin configured for insertion into said base;
the second attachment device includes a cam connected to the second pin and includes a bracket connected to the line or rope; and
the cam is configured to cause rotation of the bracket to at least partially control the tension of the line or rope.

19. The cover locking system of claim 18, wherein the bracket is configured to rotate relative to the cam about a first axis, the cam is configured to rotate about a second axis, and the first axis is offset from the second axis.

20. The cover locking system of claim 18, wherein the first attachment device includes an attachment formation that includes a hoop-shaped configuration, wherein the attachment formation is connected to the line or rope.
